(19) United States
(12) Patent Application Publication
(10) Pub. No.: US 2002/0048162 A1
(43) Pub. Date: Apr. 25, 2002

(54) SURFACE LIGHT SOURCE DEVICE OF SIDE LIGHT TYPE

(75) Inventors: SHINGO OHKAWA, KOSHIGAYA-SHI (JP); NOBUHIRO ARAI, KASUKABE-SHI (JP)

Correspondence Address: STAAS & HALSEY, ATTN JAMES D HALSEY JR, 700 ELEVENTH STREET NW, SUITE 500, WASHINGTON, DC, 20001

(73) Assignee: Enplas Corporation, Kawaguchi-shi (JP)

(21) Appl. No.: 09/165,210

(22) Filed: Oct. 2, 1998

(30) Foreign Application Priority Data
Oct. 7, 1997 (JP) 290491/1997

(51) Int. Cl. F21V 7/04

(52) U.S. Cl. 362/31

(57) ABSTRACT

A surface light source device comprises a primary light source, a reflection sheet, a scattering transmission sheet, a guide plate and prism sheet functioning as a light control member. The scattering transmission sheet is provided with scattering power which is given through roughening both faces, uniform containing of fine particles or other means. Light leaked from a back face of the guide plate is reflected and return to the guide plate, being scattered by the scattering transmission sheet on the way. The reflection sheet is a reflection member of high reflectance. A fluorescent lamp emits illumination light which enters into the guide plate and propagates as repeating reflections between the back face and an emission face. Meanwhile, light components having incidence angles smaller than the critical angle with respect to the emission face is emitted from the emission face. The prism sheet and the back face of the guide plate are provided with projections (arrows B, C) which are repeatedly arranged to correct directivity toward the frontal direction in planes parallel and perpendicular with respect to an incidence face of the guide plate. The scattering transmission sheet may be removed, if the reflection sheet is provided with scattering power.

### BACKGROUND

1. Field of Invention

The present invention relates to a light source device of side light type, more particularly to a light source device of side light type which is capable of avoiding interference pattern from appearing to provide illumination improved in quality.

The present invention is applied to, for instance, backlighting of a liquid crystal display.

2. Related Art

Surface light source devices of side light type have been conventionally employed, for instance, to illuminate a liquid crystal panel from its back. This arrangement is advantageous for making the overall structure thin.

In general, the light source device of side of light type comprises a rod-shaped light source such as a cold cathode tube as primary light source, which is arranged beside a guide plate (plate-shaped light guide). The primary light source emits illumination light which is introduced into the guide plate through a side end face (i.e. incidence face) thereof. Introduced light propagates inside of the guide plate while outputting emission from a major face (i.e. emission face) toward a liquid crystal panel.

Known guide plates employable in light source devices of side light type are of sorts, one having a substantially uniform thickness and another having a tendency to reduce thickness according to distance from the primary light source. The latter provides emission, in general, more effectively in comparison with the former.

FIG. 8 is a broken perspective view illustrating a conventional light source device of side light type which employs a guide plate of the latter sort. FIG. 9 is a cross section along line A-A in FIG. 8.

Referring to FIG. 8 and FIG. 9, a light source device of side light type 1 comprises a guide plate 2, a primary light source 3, a reflection sheet 4 and a prism sheet 5 which is functioning as a light control member. The reflection sheet 4, guide plate 2 and prism sheet 5 are laminatedly arranged. The primary light source 3 is disposed beside the guide plate 2.

The glide plate 2 is made of a scattering and guiding material with a wedge-shaped cross section, being called scattering guide plate. The scattering and guiding material is composed of matrix, such as PMMA (polymethyl methacrylate), and a great number of light-permeable fine particles which are dispersed uniformly therein. The fine particles are different from the matrix in refractive index.

The primary light source 3 includes a cold cathode tube (fluorescent lamp) 7 backed by a reflector 8 which is generally semi-circular in cross section. Illumination light is supplied to side end face, an incidence face 2A, of the scattering guide plate 2 through an opening of the reflector 8.

The reflection sheet 4 is a sheet-like member with regular reflectivity such as metal foil or irregular reflectivity such as white PET film.

Illumination light is introduced into the guide plate 2 through the incidence face 2A and propagates toward a distal end while repeating reflections at two major faces (back face 2B and emission face 2C). Illumination light is therewith subject to scattering effect of the fine particles within the guide plate 2. If the reflection sheet 4 is an irregular reflection member, there will be added irregular reflection effect.

Repeated reflections by the inclined back face 2B will give the illumination light reducing incidence angles with respect to the emission face 2C. Such reduction in incedence angle increases components which are angularly smaller than the critical angle with respect to the emission face 2C, thereby promoting emission from the emission face. This prevents emission intensity from being insufficient in an area distant from the primary light source 3.

The emission face 2C outputs illumination light which assumes scattering light because it has been subject to scattering effect of the fine particles within the guide plate 2 and in some cases, further has been undergone irregular reflection effect of the reflection sheet 4.

However illumination light outputted from the emission face 2C has a principal propagation direction inclined toward the distal end with respect to the frontal direction in a plane perpendicular to the incidence face 2A (i.e. toward a direction as distancing the incidence face 2A). That is, the output light of the scattering guide plate 2 has directivity. This property is called emission directivity.

Provided that the back face 2B is flat, illumination light outputted from the emission face 2C propagates divergently and symmetrically with respect to the frontal direction in a plane parallel to the incidence face 2A. That is, viewing from the incidence face 2A, the illumination light contains components which propagate toward obliquely and upward both sides. To correct this and increase frontal emission a prismatic surface (light control surface) is formed also on the back face 2B.

The prismatic surface is provided with a great number of parallel prismatic rows. The prismatic rows run generally at right angles with respect to the incidence face 2A. As indicated by arrow B, each prismatic row is a row fine projection such as one having triangular cross section. Slopes 2E, 2F of the projections correct propagation direction of light so that emission toward the frontal direction are increased.

The prism sheet 5 disposed along the emission face 2C is a light-permeable sheet material such as polycarbonate. The prism sheet 5 is provided with a prismatic surface including a great number of parallel prismatic rows. The is arranged in an orientation such that the prismatic face is directed toward the guide plate 2 and the prismatic rows run generally parallel to the incidence face 2A.

A double-surfaces prism sheet with prismatic surfaces on both faces may be employed. In the case, prismatic rows on its outer face run generally at right angles with ones on its inner face. The prismatic rows on the outer face correct light angularly toward the frontal direction in a plane parallel to the incidence face 2A.

It is to be noted that increased intensity of emission is realized by employing a high reflectance member with regular reflectivity as the reflection sheet 4 in a surface light source device of side light type of the above sort. According to experiments, a regular reflection member made of a so-called silver sheet could cause average emission intensity to increase about 10% compared with employment of a white PET film which is in irregular reflectivity member.

The experiments were performed for the arrangement described with reference to FIG. 8. Each pair of slopes 2E and 2F gave a vertical angle of 100 degrees. The prism sheet 5 gave a vertical angle of 47.5 degrees. Silver was evaporation-deposited on a base material and a protection film was applied thereonto to prepare a silver sheet which is a regular reflectivity member capable of reflecting light with its specular surface. In a case such a silver sheet employed as the reflection sheet 4, average luminance of 3541 cd/m2 was obtained. On the other hand, a white PET film employed as the reflection sheet 4 gave average luminance of 3109 cd/m2.

From such results, it is supposed that a regular reflection member of high reflectance is preferable for the reflection sheet 4.

However employment of such a regular reflection member of high reflectance leads to a problem that interference pattern appears on the emission face 2C of the guide plate 2. Bright-dark stripes of the interference pattern decrease illumination output quality of the surface light source device 1.

### OBJECT AND SUMMARY OF INVENTION

Under the above-described background, the present invention intends to provide a surface light source device of side light type which is capable of providing illumination output of high average luminance without interference pattern.

The present invention is applied to a surface light source device of side light type comprising a guide plate having two major faces to provide an emission face and a back face as well as a primary light source for supplying illumination light to a side end face of said guide plate. The back face provides a light control surface including repeatedly arranged projections running generally at right angles with respect to the side end face while a reflection sheet is disposed along the back face so that light leaked from the back face is reflected by the reflection sheet and returned to the guide plate.

According to a feature of the present invention, light leaked from the back face is subject to scattering effect on the way between leaking and return to the guide plate via reflection by the reflection sheet, thereby preventing interference pattern from appearing on the emission face.

A scattering transmission sheet to scatter and transmit light leaked from the back face and a reflection sheet provided with regular reflectivity may be disposed along the back face in order. The scattering transmission sheet may be a light permeable sheet member provided with a rough surface. Otherwise, it may be a light permeable sheet member containing a great number of fine particles inside.

According to another embodiment, a reflection sheet with irregular reflectivity is disposed along the back face of the guide plate. The reflection sheet consists of a base material with metal evaporation-deposited thereon. In every embodiment, degree of light route overlapping between inner reflection components and outer reflection components is reduced, thereby preventing interference pattern from appearing.

Inner reflection component light routes are paths which are subject to inner reflection by the back face of the light guide and led to the emission face. Outer reflection component light routes are paths which are led to the emission face via leaking from the back face of the light guide, reflection by the reflection sheet and return into the light guide.

More details of the present invention will be understood by the following descrition with referring to the drawings.

### BRIEF DESCRIPTION OF DRAWINGS

FIG. 1 is a broken perspective view illustrating a surface light source device of side light type in accordance with the first, the second and the third embodiments of the present invention;

FIG. 2 is A diagram showing a cross section to illustrate mechanism of interference pattern appearance;

FIG. 3 is a diagram showing a cross section to illustrate mechanism of preventing interference pattern from appearance according to features of the present invention;

FIG. 4 is an iso-luminance graph illustrating an emission intensity distribution of a conventional surface light source device of side light type for the sake of comparison;

FIG. 5 is an iso-luminance graph illustrating an emission intensity distribution of a surface light source device of side light type as shown in FIG. 1;

FIG. 6 is an iso-luminance graph illustrating an emission intensity distribution of a surface light source device of side light type in accordance with the second embodiment;

FIG. 7 is an iso-luminance graph illustrating an emission intensity distribution of a surface light source device of side light type in accordance with the third embodiment;

FIG. 8 is a broken perspective view illustrating a conventional surface light source device of side light type; and,

FIG. 9 is a cross section along line A-A in FIG. 8.

### EMBODIMENTS

(1) First Embodiments

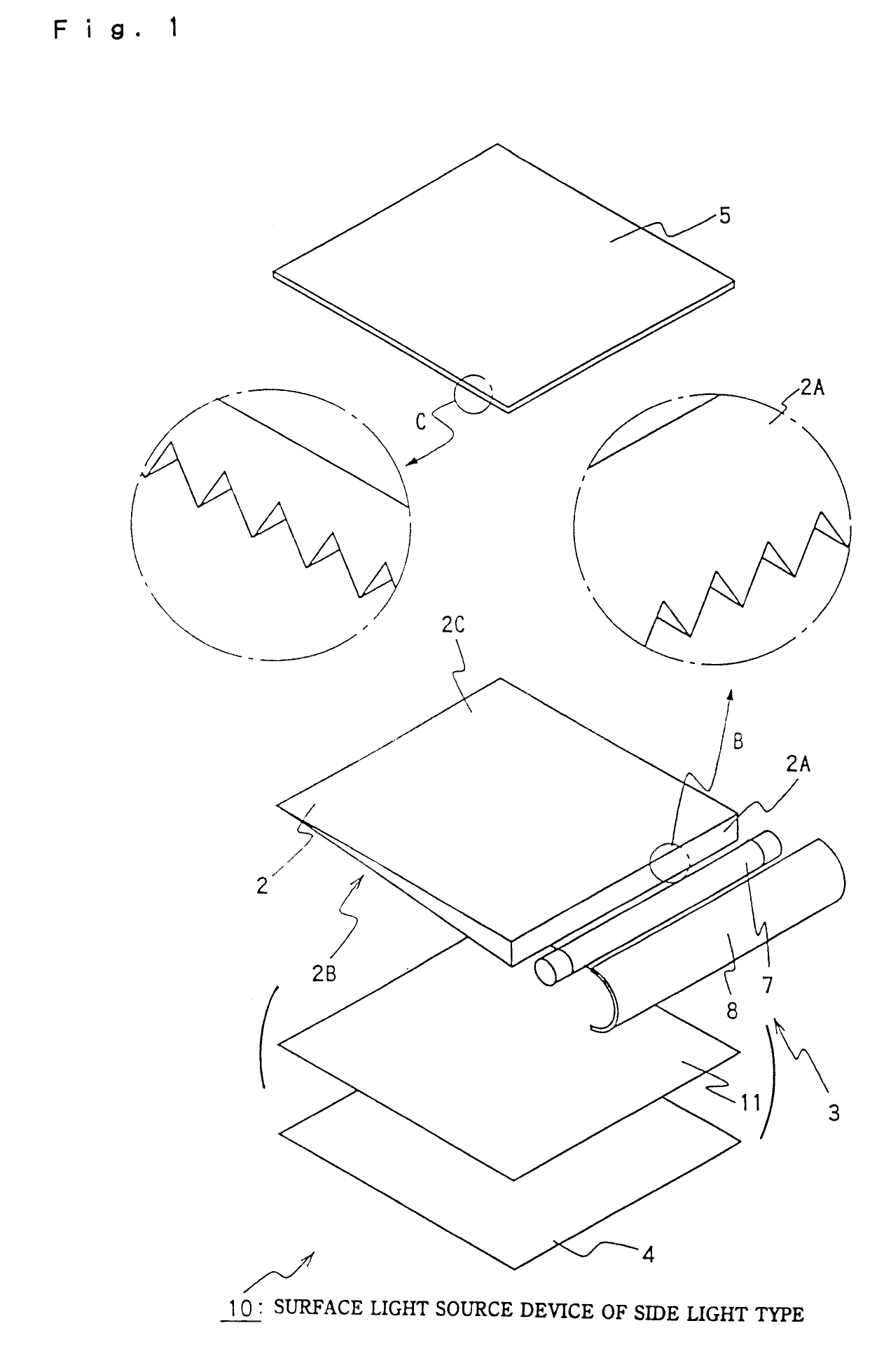

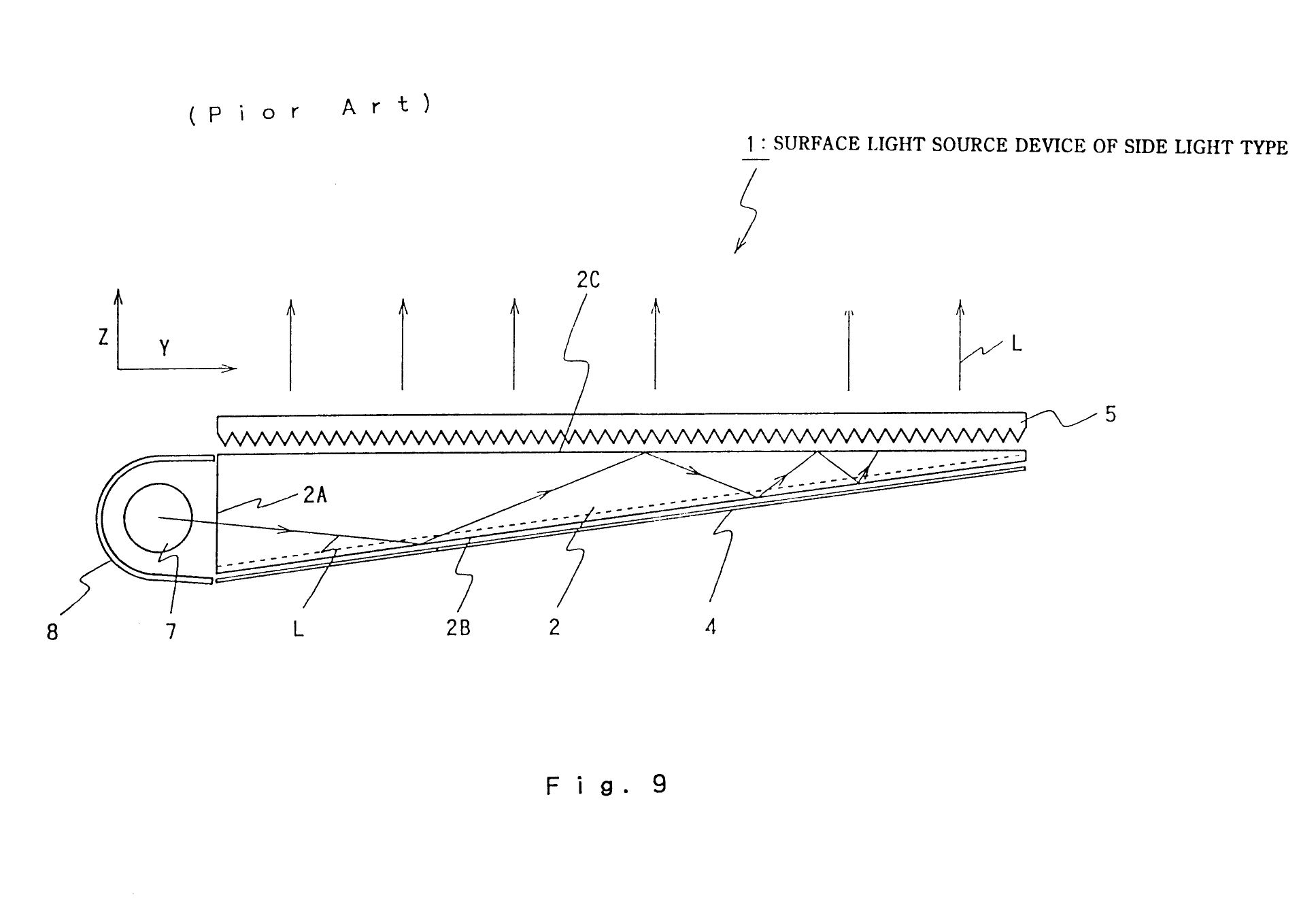

Referring to FIG. 1 it illustrates, comparatively with FIG. 8, a surface light source device of side light type 10 according to the first embodiment of the present invention. Elements common to FIG. 8 are directed by common reference symbols and repeated descriptions on them are simplified.

A surface light source device 10 comprises a primary light source 3, a reflection sheet 4, a scattering transmission sheet 11, a scattering guide plate 2 and a prism sheet 5 functioning as a light control member. The reflection sheet 4 the scattering transmission sheet 11, the scattering guide plate 2 and the prism sheet 5 are laminatedly arranged. The primary light source 3 is disposed along a side end face (incidence face) 2A of the scattering, guide plate 2. The scattering guide plate 2 includes a back face 2B and an emission face as two major faces.

The scattering transmission sheet 11 is produced by roughening both faces of a transparent sheet. Degree of roughening is such that fact of roughening is hardly recognized when printed characters or the likes are observed through the scattering transmission sheet 11. This allows illumination light leaked from the back face of the scattering guide plate 2 to be scattered and led to the reflection sheet 4 as well as to be scattered and returned to the scattering guide plate 2.

The reflection sheet 4 made of a silver sheet is a regular reflection member of high reflectance and reflects back light, leaked from the scattering guide plate 2, toward the guide plate 2 effectively.

Illumination light L emitted from the fluorescent lamp 7 is led into the scattering guide plate 2 through the incidence face 2A directly or after reflection by a reflector 8. Thus introduced illumination light propagates inside of the scattering guide plate 2 while repeating reflections at back face 2B and emission face 2C. As reflections by the back face 2B are repeated, illumination light reduces incidence angles with respect to the emission face 2C.

Light components angularly smaller than the critical angle with respect to the emission face 2C is outputted from the emission face 2C.

Repeatedly formed projections having pairs of slopes (arrow B) on the back face 2B run generally at right angle with respect to the incidence face 2A. These projections correct light angularly toward the frontal direction in a plane parallel to the incidence face 2A. Directivity of output light from the emission face 2C is then corrected angularly toward the frontal direction in a plane perpendicular to the incidence face 2A by pairs of slopes (arrow C) forming a great number of projections of the prism sheet 5. The projections of the prism sheet 5 run generally parallel to the incidence face 2A.

Illumination light leaked from the scattering guide plate 2 is returned into the scattering guide plate 2 after reflection by the reflection sheet 4 of high reflectance which is disposed along the back face 2B. Accordingly, output efficiency from the emission face 2C is high.

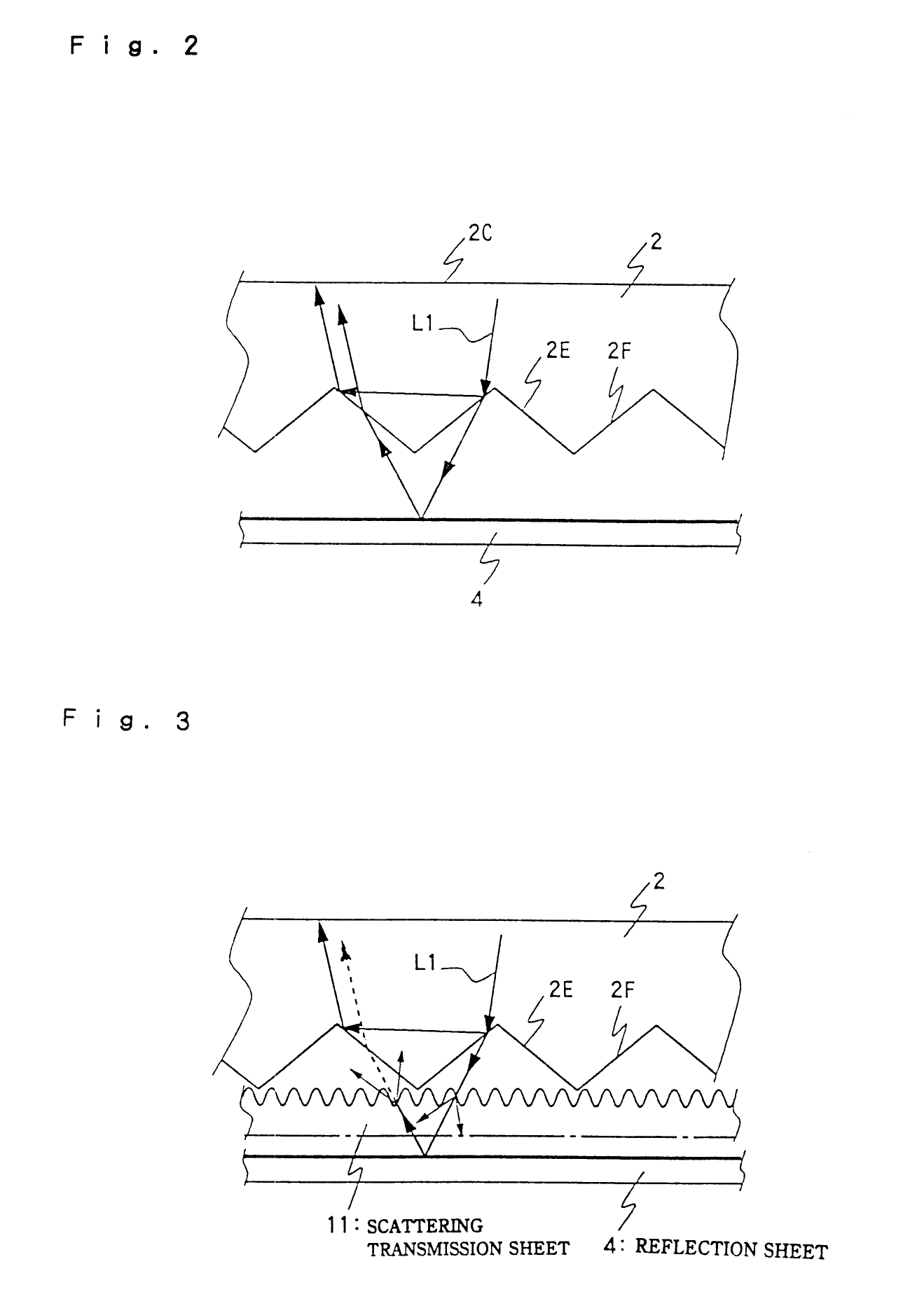

Effects of the scattering transmission sheet 11 are described with referring to FIG. 2 and FIG. 3. FIG. 2 shows a case where no scattering transmission sheet 11 is arranged (prior art). On the other hand, FIG. 3 is a case where a scattering transmission sheet 11 is arranged (present invention).

In both cases illumination light L1 to be reflected by the reflection sheet 4 is partly subject to reflection by the slopes 2E, 2F at leaving the scattering guide plate 2. Thus reflected components are reflected again by the opposite slopes 2F, 2E and proceed toward the emission surface 2C from which components angularly smaller than the critical angle are emitted. Such components are called “inner reflection components”.

In contrast this, illumination light L1 passing through the slopes 2E, 2F is regularly reflected by the reflection sheet 4 disposed closely and then returned into the scattering guide plate 2. Such components are called “outer reflection components”. The outer reflection components proceed toward the emission face 2C along paths which are roughly the same as those of the inner reflection components. It is guessed that, as a result, the case of FIG. 2 (without scattering transmission sheet 11) causes the inner and outer reflection components to be interfered with each other to generate interference pattern. If the emission face is pressed, variation of bright-dark stripes is observed. This proves that this guess is generally correct.

On the other hand, the case FIG. 3 is such that illumination light L1 is subject to scattering effect of the scattering transmission sheet 11 on the way to impinge to the reflection sheet 4. Further, scattering effect of the scattering transmission sheet 11 acts again on the way to impinge to the scattering guide plate 2.

Accordingly, illumination light L1 which are consisting of outer reflection components take dispersed routes during travel inside of the scattering guide plate 2. As a result, interference with inner reflection components is avoided well. Thus the present embodiment provides illumination output of high average luminance as well as free from interference pattern.

It should be noted that scattering power for preventing interference pattern is allowed to be given to the inside of the scattering transmission sheet 4 (please see the second and third embodiments).

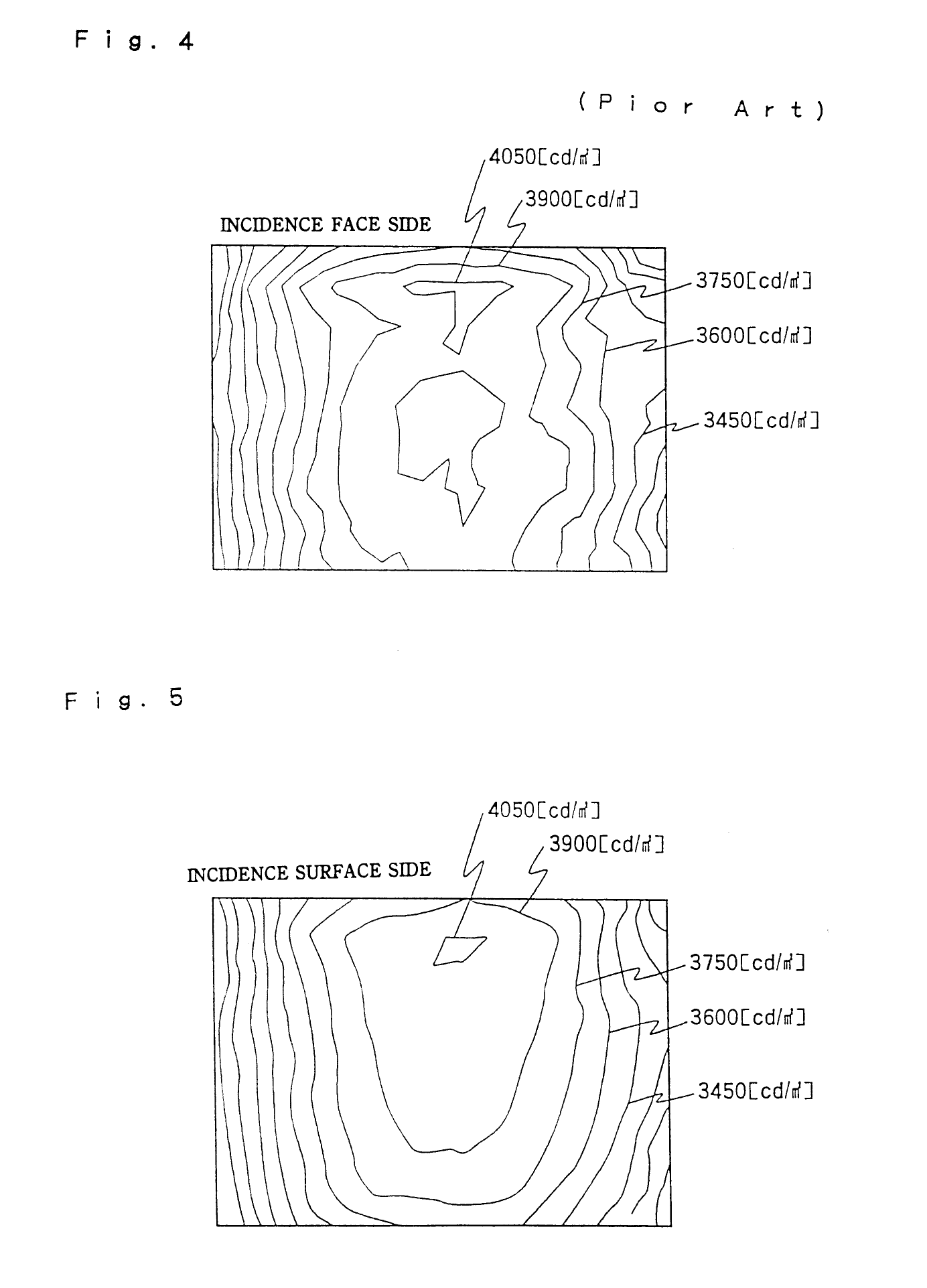

FIG. 4 is an iso-luminance graph illustrating an emission intensity distribution of a prior art surface light source device of side light type the case of FIG. 2). Vertical angle of each projection on the back face 2B is 100 degrees and that of the prism sheet 5 is 47.5 degrees.

It is understood from FIG. 4, iso-luminance curves are affected and bent unnaturally by interference pattern. Average luminance of emission is 3541 cd/m2.

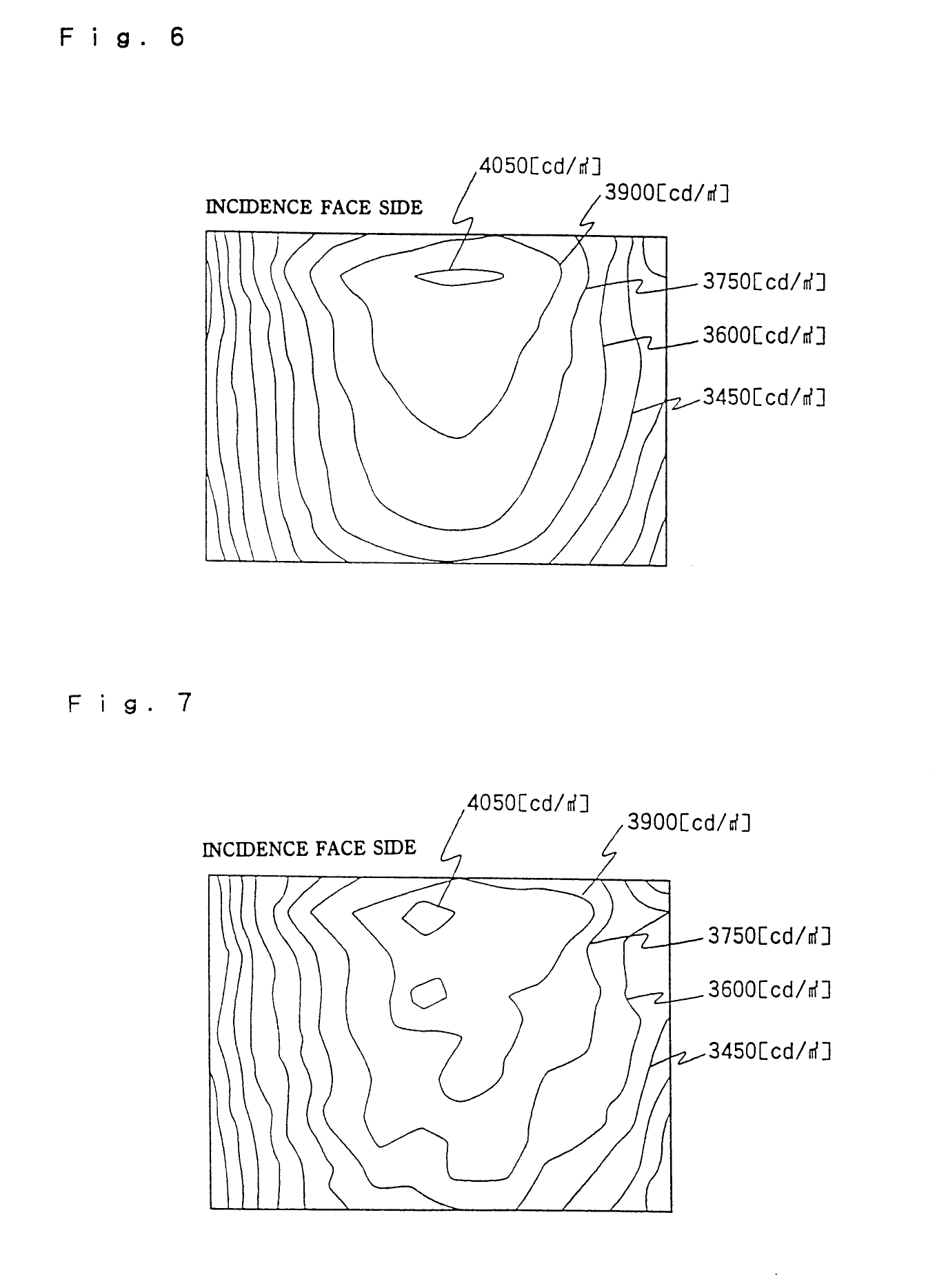

FIG. 5 is an iso-luminance graph illustrating an emission intensity distribution of a surface light source device according to the first embodiment. Vertical angle conditions are the same as those of FIG. 4. That is, vertical angle of slopes 2E. 2F is 100 degrees and prismatic vertical angle of the prism sheet 5 is 47.5 degrees.

As plotted in FIG. 5, iso-luminance curves are free from unnatural bending. This means that interference pattern is reduced to scarcely visible degree. Average luminance of emission is 3462 cd/m2. Only a slight reduction in intensity results from arrangement of the scattering transmission sheet 11.

(2) Second Embodiment

The present embodiment provides a surface light source device which is generally the same as the first embodiment in structure as shown in FIG. 1. The present embodiment is different from the first embodiment in that scattering power is given to the inside of the scattering transmission sheet 11. In the present embodiment the scattering transmission sheet 11 is prepared in the form of a transparent member containing fine particles capable of scattering illumination light. Scattering power in the present embodiment will be strong compared with that in the first embodiment.

FIG. 6 is an iso-luminance graph illustrating an emission intensity distribution of a surface light source device according to the second embodiment. Vertical angles conditions are the same as those of FIG. 4 and FIG. 5. That is, the back face projections give a vertical angel of 100 degrees and prismatic vertical angle of the prism sheet 5 is 47.5 degrees.

As plotted in FIG. 6, iso-luminance curves are free from unnatural bending. This means that interference pattern is reduced to scarcely visible degree. Average luminance of emission is 3424 cd/m2. Reduction in intensity resulting from arrangement of the scattering transmission sheet 11 is, although slightly over the first embodiment, not large.

(3) Second Embodiment

The present embodiment provides a surface light source device structured so that the scattering transmission sheet 11, indicated with parentheses, is removed from the structure shown in FIG. 1 while the reflection sheet 4 is replaced by a reflection member of another type. That is, this embodiment employs a sheet member 4 to which mat silver is applied. This enables the present arrangement without scattering transmission sheet 11 to reduce appearance of interference pattern efficiently.

A base material with a rough surface is prepared and Ag is evaporation-deposited on the surface (rough surface). Further, a protection film is applied onto the Ag evaporation-deposited film to obtain a so-called mat silver sheet member 4. A surface of the protection film may be roughened in stead of the base material surface. This embodiment provide an advantage that less items are required because the scattering transmission sheet 11 is left out.

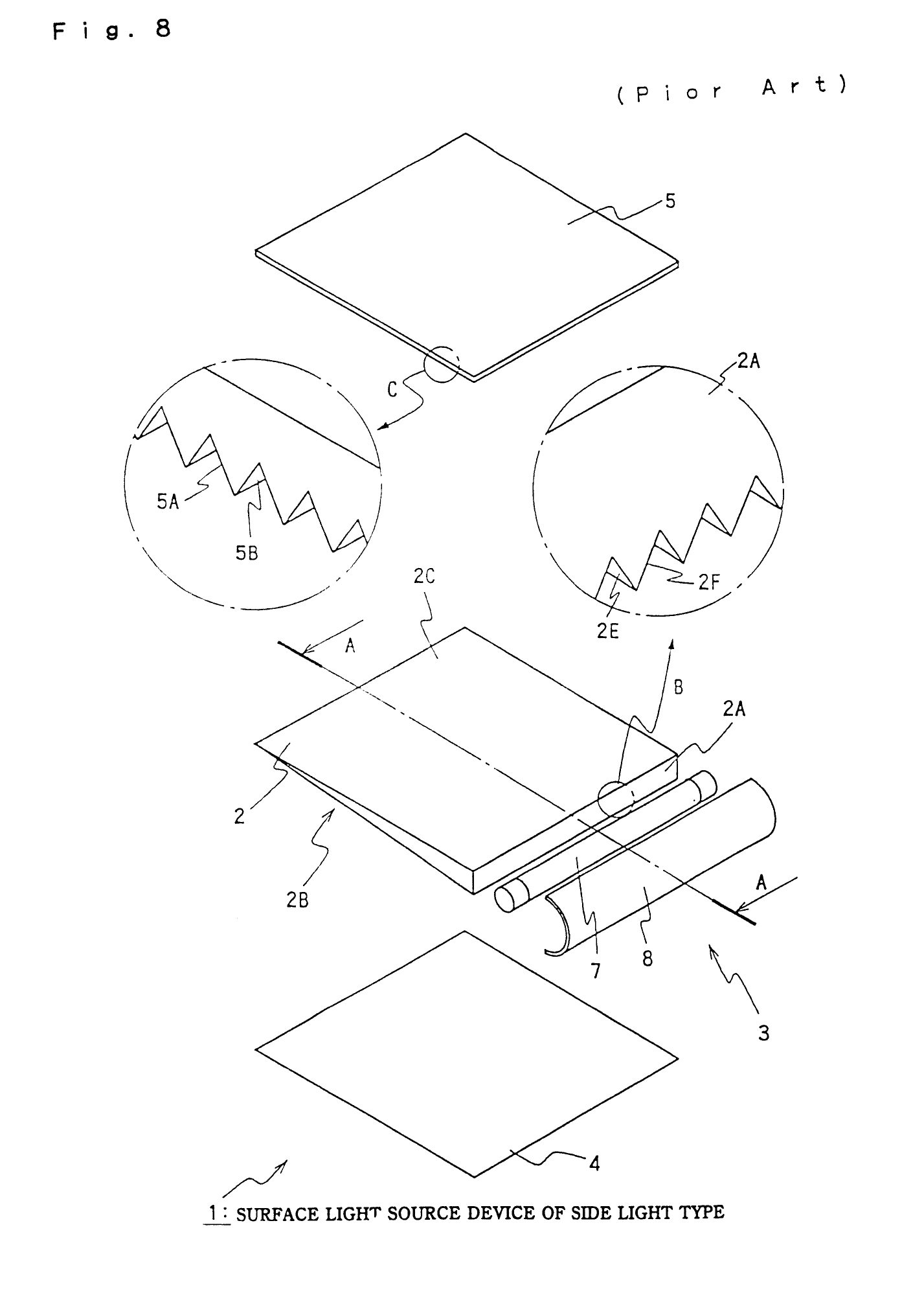

FIG. 7 is an iso-luminance graph illustrating an emission intensity distribution of a surface light source device according to the third embodiment. Vertical angle conditions are the same as those of FIG. 4, FIG. 5 and FIG. 6. That is, the back face projections give a vertical angel of 100 degrees and prismatic vertical angle of the prism sheet 5 is 47.5 degrees.

As plotted in FIG. 7 iso-luminance curves are free from unnatural bending. This means that interference pattern is reduced to scarcely visible degree. Average luminance of emission is 3301 cd/m2. Reduction in intensity resulting from arrangement of the mat silver sheet is, although over the first and second embodiments, not large.

(4) Modifications

None of the above-depicted first to third embodiments aim to be limitative for the scope of the present invention. For instance, the following modification are allowed.

(a) In the above embodiments, an Ag evaporation-deposited sheet member is employed as a reflection sheet. However, this does not limit the present invention. For example, various other metals such as aluminum may be employed for evaporation-deposition instead of silver to prepare a sheet material of high reflectance.

(b) Processings such as mat-processing or ink-deposition may be applied overall or partly to the emission face of the scattering guide plate to reinforce scattering power.

(c) Limitation is imposed on neither material nor production methods of the prism sheet 5 employed as a light control member. For instance, light permeable materials such as polycarbonate (PC) or polymethylmethacrylate (PMMA) may be employed. A sheet-like or plate-like light control member without flexibility may be employed instead of a light control member made of resin material provided with flexibility.

(d) In the above embodiments, the prism sheet is solely disposed along the emission face of the scattering guide plate. However, this does not limit the present invention. For instance, there may be arranged a scattering sheet to scatter illumination light.

(e) The scattering guide plate employed in the above-described first embodiments contains light permeable fine particles inside. However, different sorts of scattering guide plates may be employed. Further, a transparent scattering guide plate may be employed.

(f) A scattering guide plate with a cross section other than wedge-shape may be employed. For instance, a scattering guide plate having uniform thickness is employable.

(g) Incidence faces a scattering guide plate may be set at two or more side end faces. A plurality of primary light sources may be arranged accordingly.

(h) A primary light source provided with a light source element other than rod-shaped ones such as a fluorescent lamp. For instance, a plurality of point-like light source elements may be arranged to provide a primary light source.

(i) Surface light source devices in accordance with the present invention are applicable to uses other than backlight arrangement for liquid crystal displays. For instance, wide applications to various illumination devices and displays widely are practicable.

What is claimed is:

1. A surface light source device of side light type comprising a guide plate having two major faces to provide an emission face and a back face as well as a primary light source for suplying illumination light to a side end face of said guide plate;
wherein said back face provides a light control surface including repeatedly arranged projections running generally at right angles with respect to said side end face;
a reflection sheet is disposed along said back face so that light leaked from said back face is reflected by the reflection sheet and returned to said guide plate; and
said light leaked from said back face is subject to scattering effect on the way between leaking and return to said guide plate via reflection by said reflection sheet, thereby preventing interference pattern from appearing on said emission face.

2. A surface light source device of side light type comprising a guide plate having two major faces to provide an emission face and a back face as well as a primary light source for supplying illumination light to a side end face of said guide plate;
wherein said back face provides a light control surface including repeatedly arranged projections running generally at right angles with respect to said side end face; and
a scattering transmission sheet to scatter and transmit light leaked from said back face and a reflection sheet provided with regular reflectivity are disposed along said back face in order.

3. A surface light source device of side light type according to claim 2; wherein said scattering transmission sheet is a light permeable sheet member provided with a rough surface.

4. A surface light source device of side light type according to claim 2; wherein said scattering transmission sheet is a light permeable sheet member containing a great number of fine particles inside.

5. A surface light source devide of side light type comprising a guide plate having two major faces to provide an emission face and a back face as well as a primary light source for supplying illumination light to a side end face of said guide plate;
wherein said back face provides a light control surface including repeatedly arranged projections running generally at right angles with respect to said side end face; and
a reflection sheet provided with irregular reflectivity is disposed along said back face, consisting of a base material with metal evaporation-deposited thereon.
